(19) United States
(12) Patent Application Publication
(10) Pub. No.: US 2018/0272835 A1
(43) Pub. Date: Sep. 27, 2018

(54) VEHICULAR AIR CONDITIONING DEVICE

(71) Applicant: DENSO CORPORATION, Kariya-city, Aichi-pref (JP)

(72) Inventors: Kouji FUJII, Kariya-city (JP); Hiroshi NAKAJIMA, Kariya-city (JP); Takafumi MASUDA, Kariya-city (JP); Masanori MORIKAWA, Kariya-city (JP)

(21) Appl. No.: 15/756,998

(22) PCT Filed: Jun. 29, 2016
(86) PCT No.: PCT/JP2016/069265

§ 371 Date: Mar. 2, 2018

(30) Foreign Application Priority Data
Sep. 4, 2015 (JP) 2015-174831

(51) Int. Cl. B60H 1/00; B60H 1/34

(52) U.S. Cl. CPC B60H 1/00285; B60H 1/3407; B60H 1/00849

(57) ABSTRACT

A vehicular air conditioning device includes a cabin air conditioning unit having a cabin side ventilator and a temperature adjusting unit, and a seat air conditioning unit having a seat side ventilator a ventilation duct that guides at least a portion of the air temperature adjusted by the temperature adjusting unit toward the seat side ventilator. A plurality of seat side blowout portions in a seat. The plurality of seat side blowout portions include a contact side blowout portion which is formed on a surface of a portion of the seat which come into contact with a passenger when the passenger sits in the seat, and a below knee side blowout portion which is formed on a portion of the seat that faces a below knee region of the passenger.

### CROSS REFERENCE TO RELATED APPLICATIONS

The present application is based on Japanese Patent Application No. 2015-174831 filed on Sep. 4, 2015, the content of which is incorporated herein by reference.

### TECHNICAL FIELD

The present disclosure relates to an air conditioning device for vehicles which air conditions a vehicle cabin.

### BACKGROUND ART

Conventionally, it is known that vehicular seat air conditioning devices may supply air conditioned air from a front air conditioning unit disposed at the front of a vehicle cabin, through a ventilation duct, and toward a seat. Such vehicular seat air conditioning devices may blow the air conditioned air from a surface of the seat (e.g., see Patent Literature 1). The vehicular seat air conditioning device of Patent Literature 1 is configured to blow air conditioned air from a surface of a contact portion of a seat which contacts a passenger.

### PRIOR ART LITERATURES

### Patent Literature

Patent Literature 1: JP H11-28928 A

### SUMMARY OF INVENTION

In the case of Patent Literature 1, according to the seat air conditioning unit, which blows air conditioned air from a surface of a contact portion of a seat which contacts a passenger, to improve the immediacy of air conditioning, the range of air conditioning becomes localized. For this reason, there is a concern that, due to excess cooling or heating of a localized portion of the passenger, the comfort of the passenger may be adversely affected.

It is an object of the present disclosure to provide a vehicular air conditioning device in which the immediacy of air conditioning of a seat air conditioning unit is designed for, and at the same time the comfort of a passenger may be improved.

According to one aspect of the present disclosure, a vehicular air conditioning device for air conditioning a vehicle cabin includes

a cabin air conditioning unit including a cabin side ventilator that ventilates air toward the vehicle cabin, and a temperature adjusting unit that adjusts a temperature of a ventilation air ventilated by the cabin side ventilator, and

a seat air conditioning unit including a seat side ventilator that ventilates air toward a seat ventilation passage formed in a seat, and a ventilation duct that guides at least a portion of the air which is temperature adjusted by the temperature adjusting unit toward an air intake side of the seat side ventilator.

Further, a plurality of seat side blowout portions that blow out the air flowing in the seat ventilation duct are formed in the seat. The plurality of seat side blowout portions include a contact side blowout portion which is formed on a surface of a portion of the seat which come into contact with a passenger when the passenger sits in the seat, and a below knee side blowout portion which is formed on a portion of the seat that faces a below knee region of the passenger.

In this regard, the air which is temperature adjusted by the cabin air conditioning unit is configured to be blown out from the contact side blowout portion of the seat air conditioning unit, and thus the immediacy of air conditioning may be improved.

Further, the vehicular air conditioning device is configured to blow out the air, which is temperature adjusted by the cabin air conditioning unit, from the below knee side blowout portion of the seat. For this reason, as compared to a configuration where only the contact side blowout portion is formed in the seat, the effective area of air conditioning may be increased. For this reason, excess cooling or heating of a localized area of the passenger may be reduced, and so the comfort of the passenger may be improved.

Here, the space below the knees of the passenger in the vehicle cabin is susceptible to the stagnation of cold air. For this reason, air which has been temperature adjusted by the cabin air conditioning unit is blown out from the below knee side blowout portion, and thereby the stagnation of cold air in the space below the knees of the passenger in the vehicle cabin may be suppressed. Due to this, a comfortable vehicle cabin environment where temperature differences are reduced may be provided.

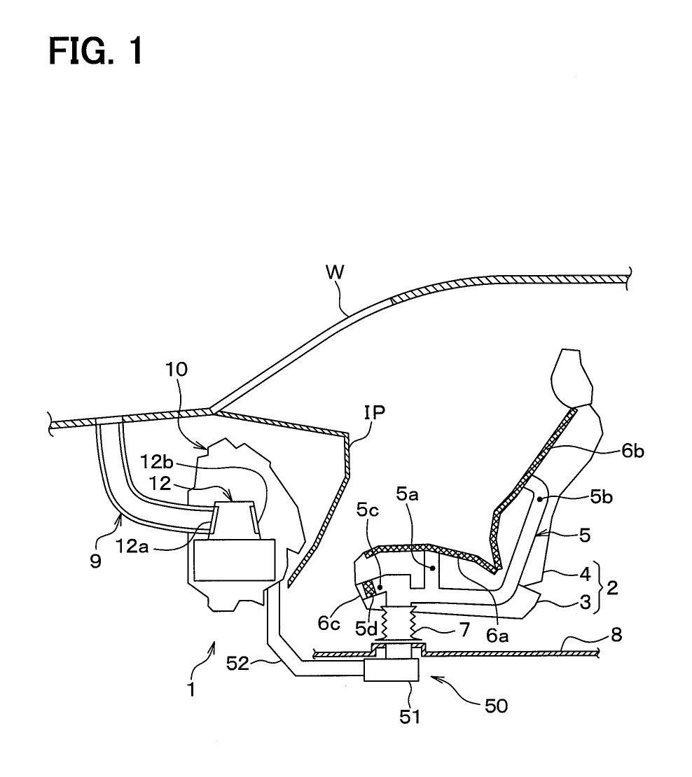

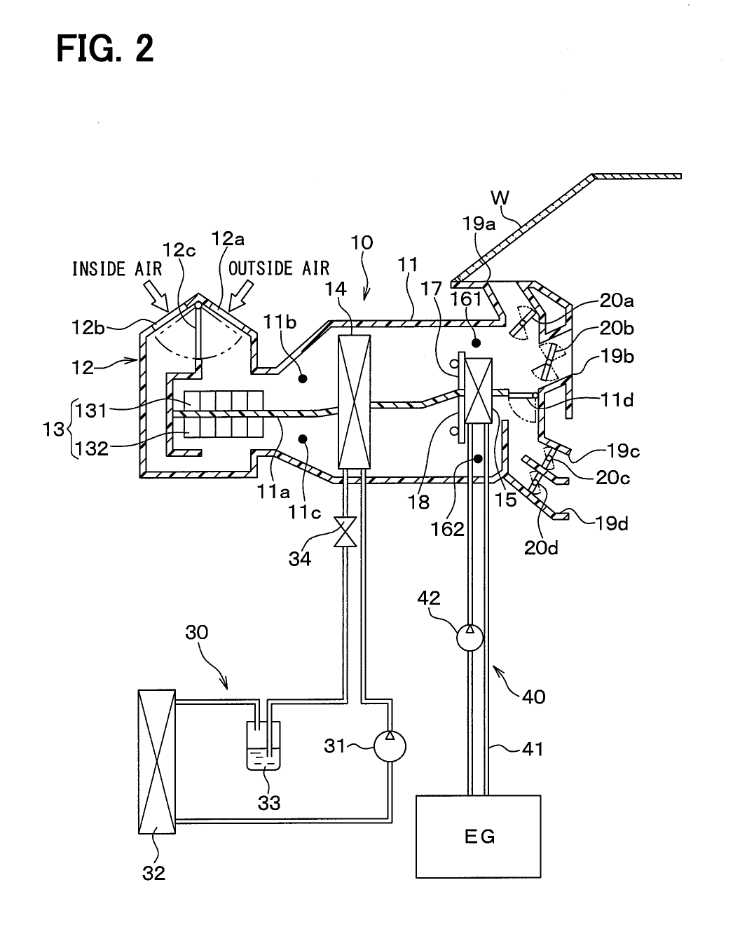

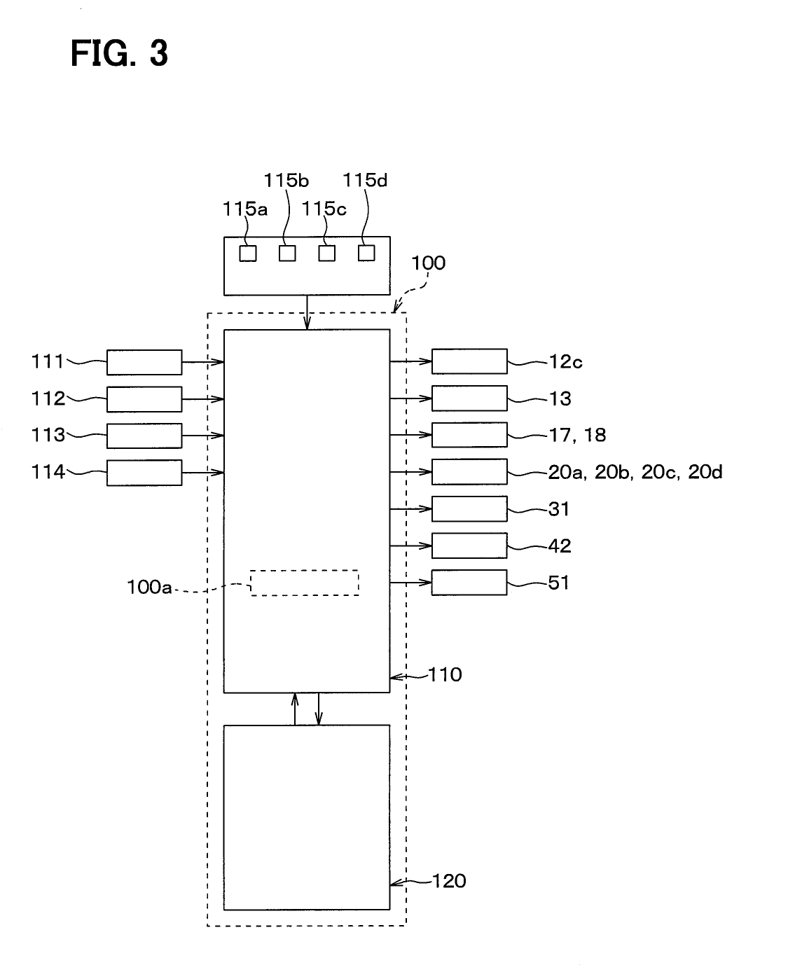

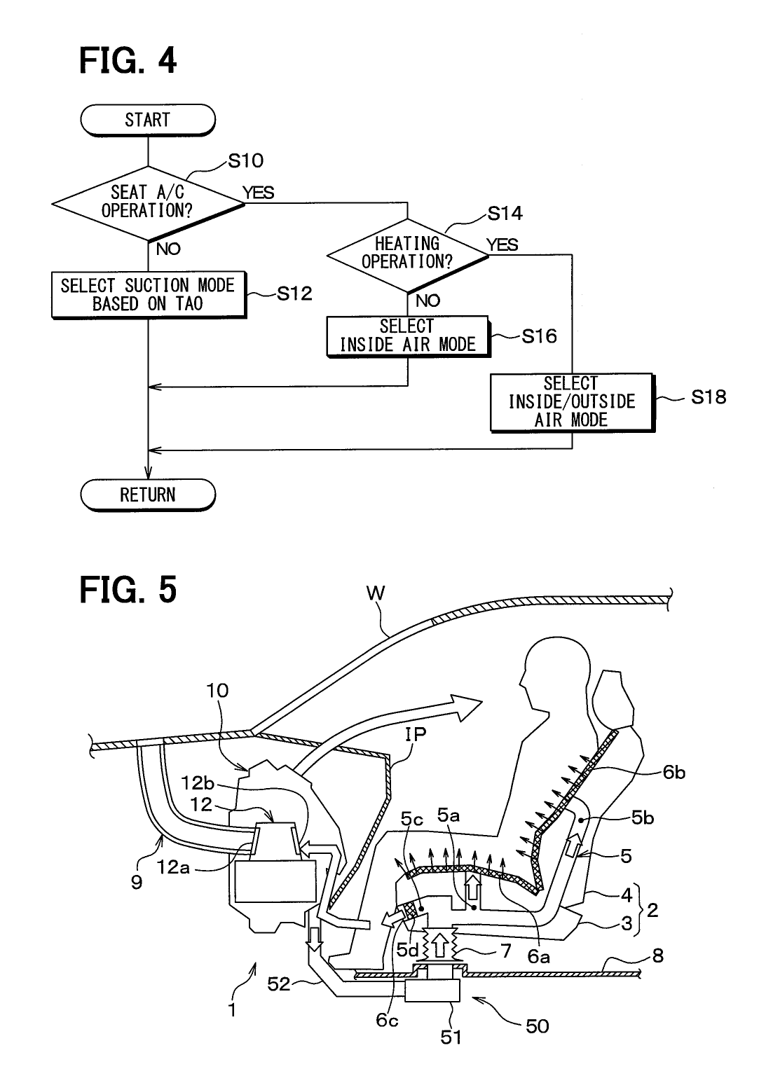

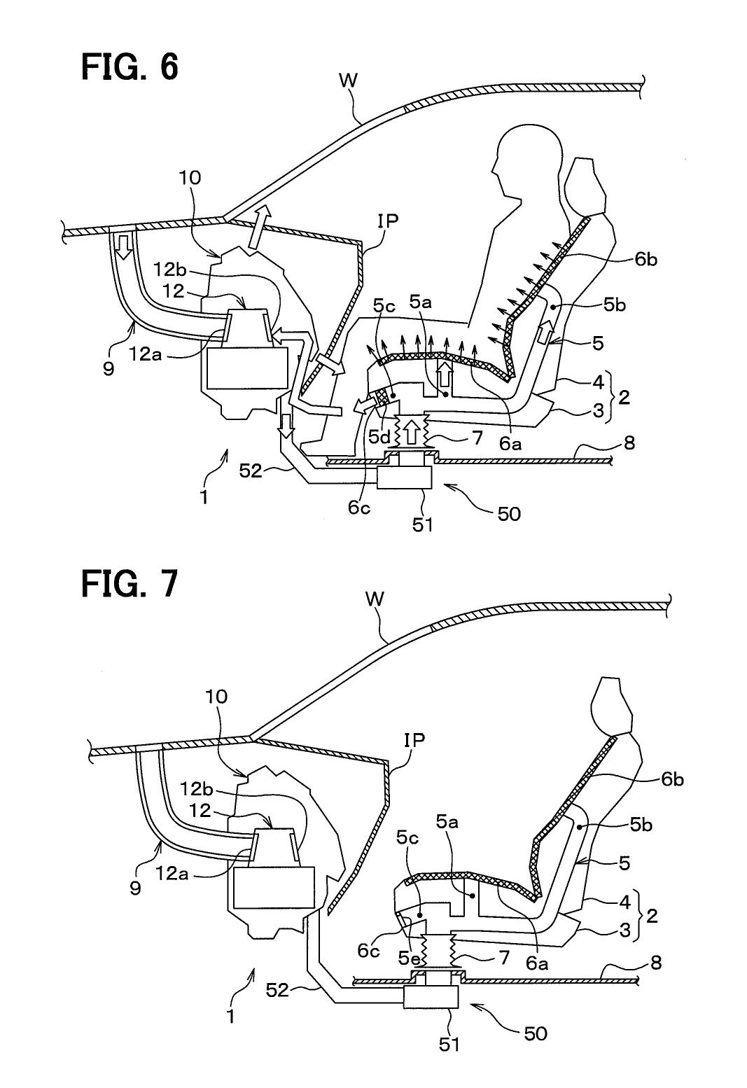

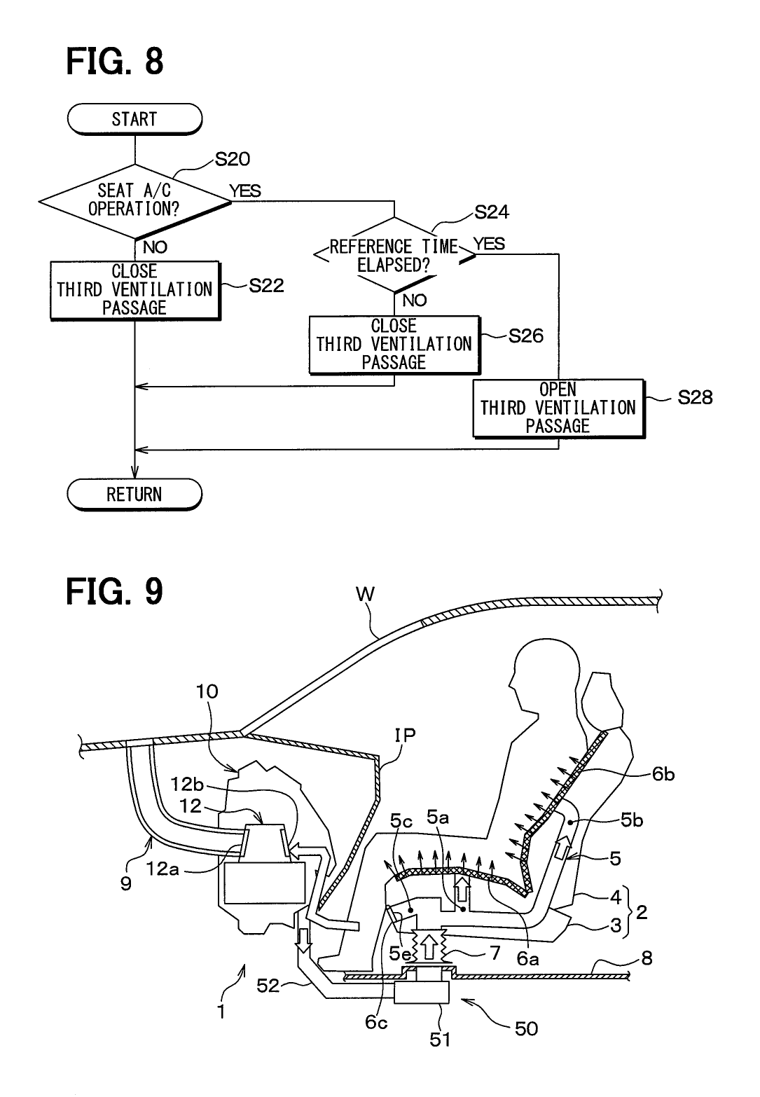

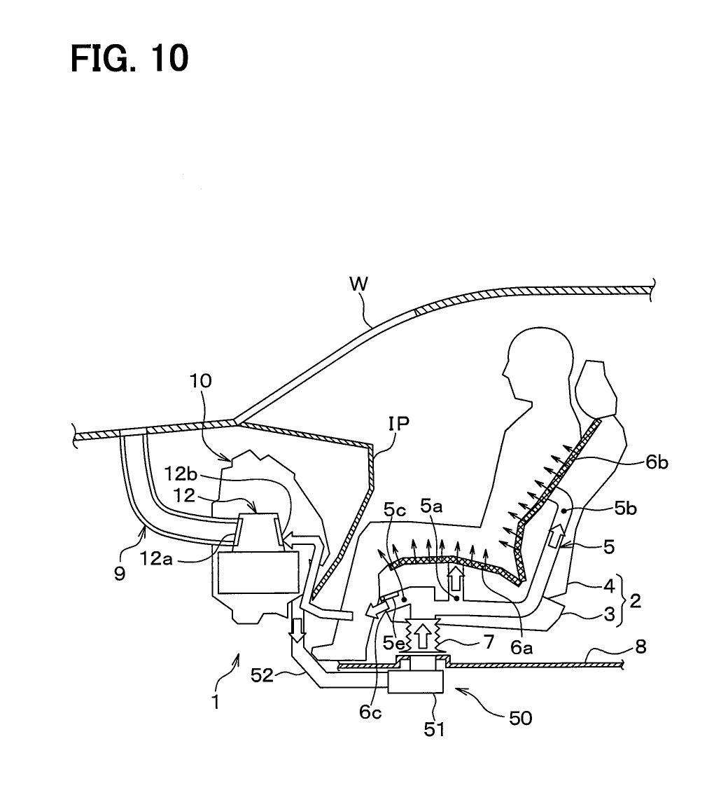

### BRIEF DESCRIPTION OF DRAWINGS

[FIG. 1] is an outline configuration view of a vehicular air conditioning device of a first embodiment.

[FIG. 2] is an outline configuration view of a seat air conditioning unit shown in FIG. 1.

[FIG. 3] is a block diagram showing a controller of a vehicular air conditioning device of a first embodiment.

[FIG. 4] is a flowchart showing the flow of a suction mode determination process performed by a controller of a vehicular air conditioning device of a second embodiment.

[FIG. 5] is an outline configuration view showing airflow in the case of cooling a passenger through seat air conditioning operation in a vehicular air conditioning device of a first embodiment.

[FIG. 6] is an outline configuration view showing airflow in the case of warming a passenger through seat air conditioning operation in a vehicular air conditioning device of a first embodiment.

[FIG. 7] is an outline configuration view of a vehicular air conditioning device of a second embodiment.

[FIG. 8] is a flowchart showing the flow of a below knee opening/closing door control process performed by a controller of a vehicular air conditioning device of a second embodiment.

[FIG. 9] is an outline configuration view showing airflow when starting operation of a seat air conditioning operation in a vehicular air conditioning device of a second embodiment.

[FIG. 10] is an outline configuration view showing airflow after a particular time period has elapsed from the start of operation of a seat air conditioning operation in a vehicular air conditioning device of a second embodiment.

### DESCRIPTION OF EMBODIMENTS

Hereinafter, embodiments will be described with reference to the figures. Further, in each of the following embodiments, portions which are the same or equivalent to previous embodiments will be denoted with the same reference numerals, and explanations thereof may be omitted for brevity.

Further, in each embodiment, if only a portion of components are explained, regarding the other portion of components, the components explained in previous embodiments may be used.

In the following embodiments, as long as no particular problems exist, the various embodiments may be partially combined with each other even if a combination is not explicitly described.

### First Embodiment

The present embodiment will be explained with reference to FIGS. 1 to 6. A vehicular air conditioning device 1 of the present embodiment is applied to a vehicle which obtains vehicular propulsion force from an internal combustion engine EG, and is a device which air conditions a vehicle cabin using the coolant of the internal combustion engine EG as a heat source. As shown in FIG. 1, the vehicular air conditioning device 1, as primary components, includes a cabin air conditioning unit 10, a seat air conditioning unit 50, and a controller 100.

First, the cabin air conditioning unit 10 is disposed within an instrument panel IP at the very front region of the vehicle cabin. As shown in FIG. 2, the cabin air conditioning unit 10 includes an air conditioning case 11 which forms its outer shell. A cabin side ventilator 13, an evaporator 14, a heater core 15, etc. are housed within the air conditioning case 11.

The air conditioning case 11 has formed therein air passages for ventilation air blown toward the vehicle cabin. In the air conditioning case 11 of the present embodiment, a partitioning plate 11a is disposed to partition the air passages formed inside the air conditioning case 11 into a first air passage 11b on the upper side and a second air passage 11c on the lower side. The first air passage 11b and the second air passage 11c are, due to the partitioning plate 11a, formed as air passages which allow air introduced from an inside/outside air switching box 12, which is described later, to flow independently.

The inside/outside air switching box 12, which switches and introduces air inside the vehicle cabin (hereinafter, “inside air”) and air outside of the vehicle cabin (hereinafter “outside air”), is disposed on the airflow most-upstream side of the air conditioning case 11. The inside/outside air switching box 12 has formed an outside air suction port 12a that introduces outside air into the air conditioning case 11, and an inside air suction port 12b that introduces inside air into the air conditioning case 11.

Here, as shown in FIG. 1, an outside air introduction duct 9 that communicates with outside of the vehicle cabin is connected to the outside air suction port 12a. Outside air is introduced into the outside air suction port 12a through the outside air introduction duct 9.

Further, the inside air suction port 12b is, at an inside of the instrument panel IP, open so as to be in communication with a lower side space of the vehicle cabin. The inside air suction port 12b is in communication with the vehicle cabin through a gap formed between the instrument panel IP and the cabin air conditioning unit 10 so as to be introduced with inside air. Further, the inner space of the instrument panel IP and the space which houses the internal combustion engine EG etc. are partitioned by a barrier wall portion having heat insulation property (not illustrated).

Returning to FIG. 2, an inside/outside air switching door 12c is disposed in the inside/outside air switching box 12. The inside/outside air switching door 12c adjusts an opening cross section of the outside air suction port 12a and the inside air suction port 12b according to a control signal from the controller 100. In the present embodiment, the inside/outside air switching door 12c corresponds to a ratio adjustment unit that adjusts a ratio between an intake amount of outside air introduced from the outside air suction port 12a and an intake amount of inside air introduced from the inside air suction port 12b.

The cabin air conditioning unit 10 of the present embodiment is able to switch between three suction modes due to the inside/outside air switching door 12c being controlled by the controller 100, as will be described later. These three suction modes include an outside air mode, an inside air mode, and an inside/outside air mode.

The outside air mode is a suction mode that introduces outside air from the outside air suction port 12a among the outside air suction port 12a and the inside air suction port 12b. Specifically, the outside air mode is a suction mode that sets the inside/outside air switching door 12c in a position to close the inside air suction port 12b, and then introduces outside air into both the first air passage 11b and the second air passage 11c.

The inside air mode is a suction mode that introduces inside air from the inside air suction port 12b among the outside air suction port 12a and the inside air suction port 12b. Specifically, the inside air mode is a suction mode that sets the inside/outside air switching door 12c in a position to close the outside air suction port 12a, and then introduces inside air into both the first air passage 11b and the second air passage 11c.

The inside/outside air mode is a suction mode that introduces inside air and outside air from both the outside air suction port 12a and the inside air suction port 12b. Specifically, the inside/outside air mode is a suction mode that sets the inside/outside air switching door 12c in a position to open both the outside air suction port 12a and the inside air suction port 12b, to introduce outside air into the first air passage 11b and introduce inside air into the second air passage 11c.

The cabin side ventilator 13 is disposed on the airflow downstream side of the inside/outside air switching box 12. The cabin side ventilator 13 is a ventilator that ventilates air, which was sucked in through the inside/outside air switching box 12, toward the vehicle cabin.

The cabin side ventilator 13 of the present embodiment is an electric ventilator including a first fan 131 disposed in the first air passage 11b, a second fan 132 disposed in the second air passage 11c, and a shared motor for driving (not illustrated). The cabin side ventilator 13 of the present embodiment is configured to be variable in rotation speed in accordance with a control signal from the controller 100. Further, as the fans of the cabin side ventilator 13, centrifugal fans, axial flow fans, crossflow fans, etc. may be used.

The evaporator 14 is disposed on the airflow downstream side of the cabin side ventilator 13. The evaporator 14 is a cooling heat exchanger that exchanges heat between a refrigerant flowing therethrough and the ventilator air blown from the cabin side ventilator 13, thereby cooling this ventilation air. Specifically, the evaporator 14 forms a vapor compression type refrigeration cycle 30 along with a compressor 31, a condenser 32, a gas-liquid separator 33, an expansion valve 34, etc.

The compressor 31 suctions in refrigerant in the refrigeration cycle 30, and then compresses and discharges the refrigerant. The compressor 31 of the present embodiment is configured so as to be driven by a driving force transmitted from the internal combustion engine EG. The compressor 31 may be changed between a driven state in which the driving force from the internal combustion engine EG is transmitted, and a stopped state in which the driving force is not transmitted. Further, the compressor 31 may be configured as an electric compressor instead as well.

The condenser 32 is an outside heat exchanger that exchanges heat between the refrigerant flowing therethrough and outside air, thereby condensing the refrigerant discharged from the compressor 31. The gas-liquid separator 33 is a receiver that separates the gas and liquid refrigerant condensed by the condenser 32, stores any excess refrigerant, and allows liquid phase refrigerant to flow further downstream. The expansion valve 34 is a decompression valve mechanism that decompresses and expands the liquid phase refrigerant flowing out from the gas-liquid separator 33. The evaporator 14 is a heat exchanger that allows the refrigerant which was decompressed and expanded by the expansion valve 34, thereby causing the refrigerant to exhibit endothermic action.

The evaporator 14 of the present embodiment is disposed so as to penetrate through a throughhole formed in the partitioning plate 11a. Accordingly, the upper side portion of the evaporator 14 is placed within the first air passage 11b, while the lower side portion of the evaporator 14 is placed within the second air passage 11c. In the present embodiment, the air flowing through the first air passage 11b is cooled by the upper side portion of the evaporator 14, and the air flowing through the second air passage 11c is cooled by the lower side portion of the evaporator 14.

Further, the heater core 15 is disposed on the airflow downstream side of the evaporator 14 within the air conditioning case 11. The heater core 15 is a heating heat exchanger that exchanges heat between a cooling water (or coolant) that cools the internal combustion engine EG and the ventilation air that passed through the evaporator 14, thereby heating the ventilation air.

Specifically, the heater core 15 and the internal combustion engine EG are connected by a cooling water pipe 41, and a cooling water circuit 40 in which cooling water circulates is formed between the heater core 15 and the internal combustion engine EG. Then, in the cooling water circuit 40, a cooling water pump 42 is disposed for circulating the cooling water. The cooling water pump 42 is configured as an electric pump whose rotation speed is controlled by a control signal output from the controller 100.

The heater core 15 of the present embodiment is disposed so as to penetrate through a throughhole formed in the partitioning plate 11a. Accordingly, the upper side portion of the heater core 15 is placed within the first air passage 11b, while the lower side portion of the heater core 15 is placed within the second air passage 11c. In the present embodiment, the air flowing through the first air passage 11b is heated by the upper side portion of the heater core 15, and the air flowing through the second air passage 11c is heated by the lower side portion of the heater core 15.

Here, a first bypass passage 161 is established on the upper side of the heater core 15 of the first air passage 11b. The first bypass passage 161 allows the air which passed through the upper side portion of the evaporator 14 to bypass the upper side portion of the heater core 15. Further, air that passes through the first bypass passage 161 merges with air heated by the heater core 15 in a space on the airflow downstream side of the heater core 15 in the first air passage 11b.

Further, a second bypass passage 162 is established on the lower side of the heater core 15 of the second air passage 11c. The second bypass passage 162 allows the air which passed through the lower side portion of the evaporator 14 to bypass the lower side portion of the heater core 15. Further, air that passes through the second bypass passage 162 merges with air heated by the heater core 15 in a space on the airflow downstream side of the heater core 15 in the second air passage 11c.

A first air mix door 17 and a second air mix door 18 are disposed in the first air passage 11b and the second air passage 11c between the evaporator 14 and the heater core 15.

The first air mix door 17 is a member that, for the air that passed through the evaporator 14, adjusts a flow quantity ratio between a ventilation air flow quantity that passes through the upper side portion of the heater core 15 and a ventilation air flow quantity that passes through the first bypass passage 161.

The second air mix door 18 is a member that, for the air that passed through the evaporator 14, adjusts a flow quantity ratio between a ventilation air flow quantity that passes through the lower side portion of the heater core 15 and a ventilation air flow quantity that passes through the second bypass passage 162. The first air mix door 17 and the second air mix door 18 of the present embodiment are each configured so as to be independently controllable by control signals output from the controller 100.

The cabin air conditioning unit 10 of the present embodiment is able to adjust the temperature of ventilation air through the evaporator 14, the heater core 15, the first air mix door 17, and the second air mix door 18. Accordingly, in the present embodiment, the evaporator 14, the heater core 15, the first air mix door 17, and the second air mix door 18 constitute a temperature adjusting unit in the cabin air conditioning unit 10 that adjusts the temperature of the ventilation air ventilated the cabin side ventilator 13.

Here, in the present embodiment, a communication hole that penetrates both sides of the partitioning plate 11a is formed at a portion of the partitioning plate 11a on the airflow downstream side of the heater core 15. An opening/closing door 11d is disposed to open or close this communication hole. The operation of the opening/closing door 11d is controlled by a control signal output from the controller 100. The opening/closing door 11d of the present embodiment is controlled so as to close the communication hole when the inside/outside air mode is set as the suction mode, and to open the communication hole in other suction modes.

At the most-downstream portion of the air conditioning case 11 in the airflow direction, first to fourth blowout opening portion 19a to 19d which blow out the temperature adjusted air in the air conditioning case 11 are disposed.

The first blowout opening portion 19a is an opening portion that blows out air toward an inner side of a window glass W of a front part of the vehicle. The second blowout opening portion 19b is an opening portion that blows out air toward the upper half body of a passenger in the vehicle cabin. The third blowout opening portion 19c is an opening portion that blows out air toward the feet of a passenger. The fourth blowout opening portion 19d is an opening portion that blows out air to a ventilation duct 52 of the seat air conditioning unit 50.

The first blowout opening portion 19a and the second blowout opening portion 19b of the present embodiment are disposed at the airflow most-downstream portion of the first air passage 11b. Further, the third blowout opening portion 19c and the fourth blowout opening portion 19d of the present embodiment are disposed at the airflow most-downstream portion of the second air passage 11c. In the present embodiment, the fourth blowout opening portion 19d forms a seat communication portion on the airflow downstream side of the second air passage 11c, which communicates with the ventilation duct 52 of the seat air conditioning unit 50 as will be described later.

Further, on the airflow upstream side of each of the blowout opening portions 19a to 19d, first to fourth mode doors 20a to 20d that adjust an opening cross section are disposed. Each mode door 20a to 20d forms a blowout mode switching unit that switches blowout modes. The operation of each mode door 20a to 20d is controlled by control signals output from the controller 100.

In the present embodiment, the blowout modes of air into the vehicle cabin which may be changed by each mode door 20a to 20d includes a face mode, a bi-level mode, a foot mode, and a seat blowout mode.

The face mode is a blowout mode which completely opens the second blowout opening portion 19b and blows out air from the second blowout opening portion 19b toward the upper half body of a passenger. The bi-level mode is a blowout mode that opens both the second blowout opening portion 19b and the third blowout opening portion 19c, and blows out air toward the upper half body and the lower half body of a passenger from both the second blowout opening portion 19b and the third blowout opening portion 19c. The foot mode is a blowout mode that completely opens the third blowout opening portion 19c and only opens the first blowout opening portion 19a by a small amount, and primarily blows out air from the third blowout opening portion 19c.

The seat blowout mode is a blowout mode that completely opens the fourth blowout opening portion 19d, and blows out air from the fourth blowout opening portion 19d toward the ventilation duct 52. The seat blowout mode of the present embodiment opens the second blowout opening portion 19b and blows out air from the second blowout opening portion 19b toward the upper half body of a passenger when cooling the vehicle cabin. Further, the seat blowout mode of the present embodiment opens the first blowout opening portion 19a and the third blowout opening portion 19c and blows out air from the first blowout opening portion 19a toward the glass W of the vehicle front and blows out air from the third blowout opening portion 19c toward the lower half body of a passenger when heating.

According to the present embodiment, when the suction mode is set to the inside/outside air mode, and the blowout mode is set to the foot mode, outside air introduced toward the first air passage 11b is blown toward the upper side of the vehicle cabin through the first blowout opening portion 19a. Then, the inside air introduced toward the second air passage 11c is blown out toward the lower side of the vehicle cabin through the third blowout opening portion 19c.

Further, according to the present embodiment, when the suction mode is set to the inside/outside air mode, and the blowout mode is set to the bi-level mode, outside air introduced toward the first air passage 11b is blown toward the upper side of the vehicle cabin through the second blowout opening portion 19b. Then, the inside air introduced toward the second air passage 11c is blown out toward the lower side of the vehicle cabin through the third blowout opening portion 19c.

Further, according to the present embodiment, when the suction mode is set to the inside/outside air mode, and the blowout mode is set to the seat blowout mode, outside air introduced toward the first air passage 11b is blown toward the upper side of the vehicle cabin through one of the first blowout opening portion 19a or the second blowout opening portion 19b. Then, the inside air introduced toward the second air passage 11c is blown out toward the ventilation duct 52 through the fourth blowout opening portion 19d.

In this regard, according to the present embodiment, when the suction mode is set to the inside/outside air mode, and the blowout mode is set to any one of the foot mode, the bi-level mode, or the seat blowout mode, an inside/outside air two layer flow mode is set.

Next, the seat air conditioning unit 50 will be explained. As shown in FIG. 1, the seat air conditioning unit 50 is an air conditioning unit that blows out the air which has been temperature adjusted by the cabin air conditioning unit 10 from a surface of a seat 2, thereby conferring comfort to a passenger. The seat air conditioning unit 50 is installed with a seat 2 disposed at the front of the vehicle. The seat 2 includes a seat cushion portion 3 for supporting the lower half body of a passenger, and a seat back portion 4 for supporting the upper half body of a passenger.

A seat blowout portion 6a, a back blowout portion 6b, and a below knee blowout portion 6c are provided in the seat 2 as seat side blowout portions that blow out air toward a passenger side. Hereinafter, each blowout portion 6a to 6c will be explained.

First, the seat blowout portion 6a is a blowout portion that blows out air from the surface of the seat cushion portion 3 toward the buttock or thigh area of a passenger. The seat blowout portion 6a of the present embodiment is configured with a plurality of micropores, which are not illustrated, formed on the upper surface of the seat cushion portion 3.

Next, the back blowout portion 6b is a blowout portion that blows out air from the surface of seat back portion 4 toward the lower back or back of a passenger. The back blowout portion 6b of the present embodiment is configured with a plurality of micropores, which are not illustrated, formed on the front surface of the seat back portion 4.

The seat blowout portion 6a and the back blowout portion 6b are formed on the surface of portions of the seat 2 which come into contact with a passenger when the passenger sits in the seat 2. Accordingly, in the present embodiment, the seat blowout portion 6a and the back blowout portion 6b form a contact side blowout portion which is formed on the surface of portions of the seat 2 which come into contact with a passenger when the passenger sits in the seat 2.

Next, the below knee blowout portion 6c is a blowout portion that blows out air from the seat cushion portion 3 toward the below knee region of a passenger. The below knee blowout portion 6c is formed at a front portion of the seat cushion portion 3 which faces the below knee region of a passenger, e.g., facing the calves of a passenger. Accordingly, in the present embodiment, the below knee blowout portion 6c forms a below knee side blowout portion which is formed on a portion of the seat 2 that faces the below knee region of a passenger.

Specifically, the below knee blowout portion 6c of the present embodiment is formed closer toward the rear side of the vehicle as compared to the inside/outside air switching box 12, and is configured with an opening portion formed on the front surface of the seat cushion portion 3 so as to blow out air toward the vehicle front side, i.e., toward the inside/outside air switching box 12. The below knee blowout portion 6c may be configured with a plurality of micropores, a single opening hole, or a plurality of opening holes, etc. The below knee blowout portion 6c may have opening shapes of rectangles, circles, or ellipses, etc.

Further, a seat ventilation passage 5 is formed inside the seat 2. The seat ventilation passage 5 guides air supplied from the seat air conditioning unit 50 to the seat blowout portion 6a, the back blowout portion 6b, and the below knee blowout portion 6c formed in the seat 2.

The seat ventilation passage 5 of the present embodiment branches off within the seat 2 such that air may be blown out from each of the seat blowout portion 6a, the back blowout portion 6b, and the below knee blowout portion 6c. Specifically, the seat ventilation passage 5, within the seat 2, branches in a first ventilation passage 5a that guides air to the seat blowout portion 6a, a second ventilation passage 5b that guides air to the back blowout portion 6b, and a third ventilation passage 5c that guides air to the below knee blowout portion 6c.

A connection duct 7 that connects to the seat air conditioning unit 50 is disposed at the airflow most-upstream portion of the seat ventilation passage 5. The connection duct 7 has one end side connected to an airflow inlet side of the seat ventilation passage 5, and another end side connected to an airflow outlet side of a seat side ventilator 51 of the seat air conditioning unit 50. The connection duct 7 is disposed between the seat 2 and a floor 8. The connection duct 7 is configured with a bellow shape so as to be able to deal with movements in seat position in the up-down direction or the front-rear direction. Further, the connection duct 7 may be a duct other than a bellow shaped duct as long as a flexible duct is used.

The seat air conditioning unit 50 includes the seat side ventilator 51 which ventilates air to the seat ventilation passage 5 formed in the seat 2, and the ventilation duct 52 which guides at least a portion of the air temperature adjusted by the cabin air conditioning unit 10 toward the seat side ventilator 51.

The seat side ventilator 51 is disposed below the floor 8 which faces the lower surface of the seat 2. The seat side ventilator 51 sucks in air from the ventilation duct 52 side, and blows out this air through the connection duct 7 toward the seat ventilation passage 5.

The seat side ventilator 51 of the present embodiment is configured as an electric ventilator whose rotation speed may be changed according to a control signal from the controller 100. Further, as the fan of the seat side ventilator 51, centrifugal fans, axial flow fans, crossflow fans, etc. may be used.

The ventilation duct 52 is, similar to the seat side ventilator 51, disposed in the floor 8 of the vehicle. The ventilation duct 52 has one end connected to the fourth blowout opening portion 19d disposed in the cabin air conditioning unit 10, and another end connected to the air intake side of the seat side ventilator 51.

Here, in the present embodiment, the first ventilation passage 5a and the second ventilation passage 5b form a contact side ventilation passage that spans from the air discharge side of the seat side ventilator 51 to the seat blowout portion 6a and the back blowout portion 6b which form the contact side blowout portion. Further, in the present embodiment, the third ventilation passage 5c forms a below knee side ventilation passage that spans from the air discharge side of the seat side ventilator 51 to the below knee blowout portion 6c.

The seat blowout portion 6a and the back blowout portion 6b are partially blocked by the body of a passenger when the passenger sits in the seat 2. Due to this, when a passenger sits in the seat 2, the ventilation resistance in the first ventilation passage 5a and the second ventilation passage 5b, which form the contact side ventilation passage, is increased.

For this reason, for example, if the ventilation resistance of the first ventilation passage 5a and the second ventilation passage 5b were equal to the ventilation resistance of the third ventilation passage 5c when a passenger is not sitting in the seat 2, then it may be difficult for air to flow in the first ventilation passage 5a and the third ventilation passage 5c when a passenger sits in the seat 2. This may adversely affect the immediacy of air conditioning.

Here, according to the present embodiment, the ventilation resistance of the third ventilation passage 5c is configured to be greater than the ventilation resistance of the first ventilation passage 5a and the second ventilation passage 5b when a passenger is not sitting in the seat 2. Specifically, in the present embodiment, a resistive element 5d is disposed in the third ventilation passage 5c such that the ventilation resistance of the third ventilation passage 5c is greater than the ventilation resistance of the first ventilation passage 5a and the second ventilation passage 5b when a passenger is not sitting in the seat 2. As the resistive element 5d, a mesh element which is breathable may be used. As an alternative, the passage cross section area of the third ventilation passage 5c may be reduced as compared to the passage cross section are of the first ventilation passage 5a and the second ventilation passage 5b, such that the ventilation resistance of the third ventilation passage 5c is increased as compared to the ventilation resistance of the first ventilation passage 5a and the second ventilation passage 5b.

Next, with reference to FIG. 3, the controller 100 of the present embodiment, which is an electronic control unit, will be explained. The controller 100 includes an air conditioning controller 110 and a driving controller 120. The air conditioning controller 110 and the driving controller 120 include a microcomputer having a CPU, ROM, RAM, etc. as well as peripheral circuits thereof. Further, the air conditioning controller 110 and the driving controller 120 are configured to perform processing based on control programs etc. stored within their ROM, and control the operations of various devices connected on the output side. Further, the storage units of the controller 100 are non-transitory, tangible storage medium.

First, the air conditioning controller 110 is a device that controls the operation of the cabin air conditioning unit 10 and the seat air conditioning unit 50. The output side of the air conditioning controller 110 is connected to the inside/outside air switching door 12c, the cabin side ventilator 13, each air mix door 17, 18, the first to fourth mode doors 20a to 20d, etc. which are component devices the cabin air conditioning unit 10. Further, the output side of the air conditioning controller 110 is connected to the compressor 31 which is a component device of the refrigeration cycle 30, the cooling water pump 42 which is a component device of the cooling water circuit 40, the seat side ventilator 51 which is a component device of the seat air conditioning unit 50, etc.

The input side of the air conditioning controller 110 is connected to an inside air sensor 111 that detects an inside air temperature Tr, an outside air sensor 112 that detects an outside air temperature Tam, and a sunlight sensor 113 that detects a sunlight amount Ts of the vehicle cabin. Further, the input side of the air conditioning controller 110 is connected to various sensor groups for air conditioning controls, such as a cooling water temperature sensor 114 that detects a temperature Tw of cooling water flowing out from the internal combustion engine Eg.

Further, the input side of the air conditioning controller 110 is connected to an operation panel 115 disposed around the instrument panel IP. The operation panel 115 is provided with various operation switches including an air conditioning operation switch 115a, a driving mode switching switch 115b, a cabin temperature setting switch 115c, a seat operation switch 115d for the seat air conditioning unit 50, etc.

The air conditioning operation switch 115a is a switch that outputs a request signal to the air conditioning controller 110 for operating the cabin side ventilator 13 and performing a temperature adjustment in the cabin air conditioning unit 10 of the air blown into the vehicle cabin.

The seat operation switch 115d is a switch that outputs a request signal to the air conditioning controller 110 for operating the cabin side ventilator 13 and the seat side ventilator 51 and performing a seat air conditioning operation which blows out the air temperature adjusted by the cabin air conditioning unit 10 from the seat 2.

For example, when the vehicle cabin is being air conditioned and the seat operation switch 115d is turned on, the air conditioning controller 110 operates both the cabin side ventilator 13 and the seat side ventilator 51 to perform the seat air conditioning operation.

Meanwhile, when the vehicle cabin is being air conditioned and the seat operation switch 115d is turned off, the air conditioning controller 110 stops the seat side ventilator 51 and operates the cabin side ventilator 13 to perform non-seat air conditioning operation. In the present embodiment, the seat operation switch 115d functions as a seat air conditioning switching unit that switches between the seat air conditioning operation and the non-seat air conditioning operation.

Next, the driving controller 120 is a device that controls the operation of the internal combustion engine EG. The output side of the driving controller 120 is connected to, not illustrated, a starter that causes the internal combustion engine EG to start, a drive circuit for fuel injection valves that supply fuel to the internal combustion engine EG, etc., which are component devices of the internal combustion engine EG.

Further, the input side of the driving controller 120 is connected to, not illustrated, a throttle opening degree sensor that detects a throttle opening degree which is a depression amount of an accelerator pedal, and various sensor groups including an engine rotation speed sensor that detects a rotation speed of the internal combustion engine EG, etc.

The controller 100 of the present embodiment is configured that the air conditioning controller 110 and the driving controller 120 are connected in a manner of enabling bidirectional communication. Due to this, the controller 100 may, based on operation signals or detection signals input to one device of the air conditioning controller 110 or the driving controller 120, control the operation of the various component devices connected to the output side of the other device.

For example, the controller 100, based on a request signal requesting the increase or decrease of an operation efficiency of the internal combustion engine EG with respect to the driving controller 120, the air conditioning controller 110 may change the operating efficiency of the internal combustion engine EG.

Here, the controller 100 of the present embodiment is configured form an integration of control units that control the various devices which are control targets connected to the output side of the controller 100. Then, the controller 100 is such that the hardware and software which control the operation of the various component devices that comprise control targets function as control units that control the operation of the various component device.

For example, the controller 100 of the present embodiment is configured to, with the air conditioning controller 110 control the inside/outside air switching door 12c to switch the suction mode between one of the outside air mode, the inside air mode, or the inside/outside air mode. In the present embodiment, the hardware and software in the controller 100 that switch the suction mode form a suction mode switching unit 100a.

Next, the basic operation of the vehicular air conditioning device 1 will be explained. In the vehicular air conditioning device 1, after the internal combustion engine EG is started and the air conditioning operation switch 115a is turned on, the controller 100 controls various component devices to begin air conditioning the vehicle cabin.

In the vehicular air conditioning device 1 of the present embodiment, when the driving mode switching switch 115b is set to a cooling mode, the controller 100 controls various component devices to perform a cooling operation for cooling the vehicle cabin.

Next, the basic control situation of various component devices during the cooling mode performed by the controller 100 will be explained. First, the controller 100 controls an operation state where the driving force of the internal combustion engine EG is transmitted to the compressor 31 of the refrigerant cycle 30.

Further, the controller 100 calculates a target blowout temperature TAO based on the detection signals from various sensor groups as well as operation signals from the operation panel 115. TAO is a blowout air temperature necessary for the vehicle cabin temperature to approach a set temperature Tset which is set by the setting switch 115c. Basically, the controller 100 calculates TAO using the following equation F1 based on the set temperature Tset which is set by the setting switch 115c, the inside air temperature Tr, the outside air temperature Tam, and the sunlight amount Ts.

TAO=Kset×Tset−Kr−Tr−Kam×Tam−Ks×Ts+C (F1)

Further, in the equation F1, Kset, Kr, Kam, and Ks are control gain factors, and C is a correction constant.

Further, the controller 100, based on TAO, determines the rotation speed of the cabin side ventilator 13, the opening degrees of each of the air mix doors 17, 18, the rotation speed of the compressor 31, etc., and outputs control signals to various devices so as to attain the determined control state.

Further, the controller 100, based on the operation signal of the seat operation switch 115d, determines the operation of the seat side ventilator 51. Specifically, the controller 100 stops the seat side ventilator 51 when the seat operation switch 115d is turned off, and causes the seat side ventilator 51 to operate when the seat operation switch 115d is turned on.

Next, the controller 100 performs a suction mode determination process to determine a suction mode for sucking air in the inside/outside air switching box 12 of the cabin air conditioning unit 10, and then outputs control signals to the inside/outside air switching door 12c so as to attain the determined control state. Further, the details of the suction mode determination process will be explained in detail further below.

Further, the controller 100 determines a blowout mode based on TAO and the operation signal of the seat operation switch 115d, and then outputs control signals to each of the mode doors 20a to 20d so as to attain the determined control state.

The controller 100, when the seat operation switch 115d is turned off, sets the face mode when the TAO is in a low temperature region, sets the bi-level mode when TAO is in a mid temperature region which is higher than the low temperature region, and sets the foot mode when TAO is in a high temperature region which is higher than the mid temperature region. Further, when switching the blowout mode based on TAO, a temperature hysteresis is preferably provided so as to avoid incessant switching the blowout mode.

Meanwhile, the controller, when the seat operation switch 115d is turned on, sets the seat blowout mode which blows out air into the ventilation duct 52. In other words, when the seat operation switch 115d is turned on, the controller 100 opens the second blowout opening portion 19b and the fourth blowout opening portion 19d, and determines the blowout mode which blows out air toward the upper half body side of a passenger and toward the ventilation duct 52.

The controller 100 repeats a routine of reading operation signals and detection signals−>calculate TAO−>determine new control state−>output control signals. Due to this, during the cooling operation, in the cabin air conditioning unit 10, the ventilation air from the cabin side ventilator 13 is cooled by the evaporator 14. Then, due to the air cooled in the cabin air conditioning unit 10, the vehicle cabin may be cooled.

Next, in the vehicular air conditioning device 1, when the operation panel 115 is set in the heating mode, the controller 100 controls various component devices to perform a heating operation that warms the vehicle cabin.

Below, the basic control situation of various component devices during the heating mode performed by the controller 100 will be explained. First, the controller 100 controls the cooling water pump 42 such that the cooling water of the internal combustion engine EG flows in respect to the heater core 15.

Next, the controller 100 calculates TAO in the same manner as during the cooling mode. Then, the controller 100, based on TAO, determines the rotation speed of the cabin side ventilator 13, the opening degrees of each of the air mix doors 17, 18, the rotation speed of the compressor 31, etc., and outputs control signals to various devices so as to attain the determined control state.

Further, the controller 100, based on the operation signal of the seat operation switch 115d, determines the operation of the seat side ventilator 51. Specifically, the controller 100 stops the seat side ventilator 51 when the seat operation switch 115d is turned off, and causes the seat side ventilator 51 to operate when the seat operation switch 115d is turned on.

Next, the controller 100 performs a suction mode determination process to determine a suction mode for sucking air in the inside/outside air switching box 12 of the cabin air conditioning unit 10, and then outputs control signals to the inside/outside air switching door 12c so as to attain the determined control state. Further, the details of the suction mode determination process will be explained in detail further below.

Further, the controller 100 determines a blowout mode based on TAO and the operation signal of the seat operation switch 115d, and then outputs control signals to each of the mode doors 20a to 20d so as to attain the determined control state.

The controller 100, when the seat operation switch 115d is turned off, sets the face mode when the TAO is in a low temperature region, sets the bi-level mode when TAO is in a mid temperature region which is higher than the low temperature region, and sets the foot mode when TAO is in a high temperature region which is higher than the mid temperature region. Further, when switching the blowout mode based on TAO, a temperature hysteresis is preferably provided so as to avoid incessant switching the blowout mode.

Meanwhile, the controller, when the seat operation switch 115d is turned on, sets the seat blowout mode which blows out air into the ventilation duct 52. In other words, when the seat operation switch 115d is turned on, the controller 100 opens the first blowout opening portion 19a, the third blowout opening portion 19c, and the fourth blowout opening portion 19d, and determines the blowout mode which blows out air toward the vehicle front glass W, the lower half body side of a passenger, and toward the ventilation duct 52.

The controller 100 repeats a routine of reading operation signals and detection signals−>calculate TAO−>determine new control state−>output control signals. Due to this, during the heating operation, in the cabin air conditioning unit 10, the ventilation air from the cabin side ventilator 13 is heated by the heater core 15. Then, due to the air heated in the cabin air conditioning unit 10, the vehicle cabin may be warmed.

Next, the suction mode determination process of the present embodiment will be explained with respect to the flowchart of FIG. 4. Further, FIG. 4 shows the suction mode determination process performed by the controller 100.

As shown in FIG. 4, first, the controller 100 determines whether or not the seat air conditioning operation is being performed (S10). This determination process is determined based on whether the seat operation switch 115d is on or off. In other words, the controller 100 determines that the seat air conditioning operation is being performed when the seat operation switch 115d is on, and determines that the seat air conditioning operation is not being performed when the seat operation switch 115d is off.

If the result of the determination process at step S10 is that the seat air conditioning operation is not being performed, in other words, the current air conditioning operation is the non-seat air conditioning operation, the controller 100 selects the suction mode based on TAO (S12).

For example, the controller 100 may set the inside air mode when the TAO is in a low temperature region, set the inside/outside air mode when TAO is in a mid temperature region which is higher than the low temperature region, and set the outside air mode when TAO is in a high temperature region which is higher than the mid temperature region. Further, when switching the suction mode based on TAO, a temperature hysteresis is preferably provided so as to avoid incessant switching the suction mode.

Conversely, if the result of the determination process at step S10 is that the seat air conditioning operation is being performed, the controller determines whether the heating operation is being performed (S14). In this determination process, the heating operation is determined if the operation panel 115 is set to the heating mode, and the heating operation is determined to be untrue if the operation panel 115 is set to the cooling mode.

If the result of the determination process at step S14 is that the heating operation is not being performed, in other words, the current operating mode is the cooling mode, the controller 100 selects the inside air mode as the suction mode (S16). In other words, when the operation mode is set to the cooling mode, and the seat air conditioning operation is being performed, the controller 100 determines the suction mode to be the inside air mode.

Conversely, if the result of the determination process at step S14 is that the heating operation is being performed, in other words, the current operating mode is the heating mode, the controller 100 selects the inside/outside air mode as the suction mode (S18). In other words, when the operation mode is set to the heating mode, and the seat air conditioning operation is being performed, the controller 100 determines the suction mode to be the inside/outside air mode.

Here, FIG. 5 is a view showing airflow when performing the seat air conditioning operation during cooling of the vehicle cabin. Further, FIG. 6 is a view showing airflow when performing the seat air conditioning operation during heating of the vehicle cabin.

In the present embodiment, when performing the seat air conditioning operation during cooling, the suction mode is set to be the inside air mode, and the blowout mode is set to be the seat blowout mode which blows out cooled air from the second blowout opening portion 19b and the fourth blowout opening portion 19d.

For this reason, when performing the seat air conditioning operation during cooling, as shown in FIG. 5, cooled air is blown out from the cabin air conditioning unit 10 to the upper half body of a passenger, and a portion of the cooled air is sucked into the seat side ventilator 51 through the ventilation duct 52. Then, the cooled air sucked into the seat side ventilator 51 is blown out from the seat blowout portion 6a, the back blowout portion 6b, and the below knee blowout portion 6c through the seat ventilation passage 5 inside the seat 2. Due to this, cool air may be directly supplied to the thigh region, the buttocks region, the back, and the below knee region of the passenger, and the entire body of the passenger may be cooled.

Further, the cool air blown out from the below knee blowout portion 6c is again sucked into the inside air suction port 12b of the inside/outside air switching box 12 through the space in the lower side of the vehicle cabin. In other words, a circulation airflow is formed where the air blown out form the below knee blowout portion 6c flows into the inside air suction port 12b.

Conversely, when performing the seat air conditioning operation during heating, the suction mode is set to be the inside/outside air mode, and the blowout mode is set to be the seat blowout mode which blows out warm air from the first blowout opening portion 19a, the third blowout opening portion 19c, and the fourth blowout opening portion 19d.

For this reason, when performing the seat air conditioning operation during heating, as shown in FIG. 6, warm air with has been dehumidified to have low humidity is blown out toward the vehicle front glass W from the cabin air conditioning unit 10, and warm air is blown out toward the lower half body side of the passenger from the cabin air conditioning unit 10.

Further, a portion of the warm air which has been temperature adjusted in the cabin air conditioning unit 10 is sucked into the seat side ventilator 51 through the ventilation duct 52. Then, the warm air sucked into the seat side ventilator 51 is blown out from the seat blowout portion 6a, the back blowout portion 6b, and the below knee blowout portion 6c through the seat ventilation passage 5 inside the seat 2. Due to this, warm air may be directly supplied to the thigh region, the buttocks region, the back, and the below knee region of the passenger, and the entire body of the passenger may be warmed.

Further, the warm air blown out from the below knee blowout portion 6c is again sucked into the inside air suction port 12b of the inside/outside air switching box 12 through the space in the lower side of the vehicle cabin. In other words, a circulation airflow is formed where the air blown out form the below knee blowout portion 6c flows into the inside air suction port 12b.

The vehicular air conditioning device 1 of the present embodiment as explained above is configured to, during the seat air conditioning operation, blow out air, which has been temperature adjusted in the cabin air conditioning unit 10, from the seat blowout portion 6a and the back blowout portion 6b of the seat 2. For this reason, during the seat air conditioning operation, air, which has been temperature adjusted in the cabin air conditioning unit 10, may be directly supplied to the thigh region, the buttocks region, and the back of the passenger. As such, the immediacy of the air conditioning may be improved.

Further, the vehicular air conditioning device 1 of the present embodiment is configured to, during the seat air conditioning operation, blow out air, which has been temperature adjusted in the cabin air conditioning unit 10, from the below knee blowout portion 6c of the seat 2. For this reason, simply, as compared to a configuration where air is blown out from the seat blowout portion 6a and the back blowout portion 6b, the effective area of air conditioning may be increased. Due to this, the comfort of the passenger may be increased while reducing the likelihood of excess cooling or heating of a localized area of the passenger.

In this regard, with the vehicular air conditioning device 1 of the present embodiment, the immediacy of the seat air conditioning unit 50 may be designed for, and at the same time the comfort of a passenger may be improved.

Here, the space below the knees of the passenger in the vehicle cabin, as compared to the space above the knees of the passenger, is susceptible to the stagnation of cold air. For this reason, in the present embodiment, air which has been temperature adjusted by the cabin air conditioning unit 10 is blown out from the below knee blowout portion 6c, and thereby the stagnation of cold air in the space below the knees of the passenger may be suppressed. Due to this, a comfortable vehicle cabin environment where temperature differences are reduced may be provided.

Further, according to the present embodiment, the below knee blowout portion 6c is formed on the front surface of the seat cushion portion 3 positioned closer toward the rear side of the vehicle as compared to the inside/outside air switching box 12, and is configured to blow out air toward the front side of the vehicle. Due to this, during a suction mode that sucks in inside air, in the space below the knees of the passenger in the vehicle cabin, a circulation airflow in which the air blown out from the below knee blowout portion 6c flows into the inside air suction port 12b of the inside/outside air switching box 12 may easily form. Such a circulation airflow not only contributes to reducing temperature differences in the vehicle cabin, but also may reduce the heat load of the cabin air conditioning unit 10.

Specifically, in the present embodiment, when performing the seat air conditioning operation during cooling, the inside/outside air switching door 12c is controlled to be in the inside air mode. Due to this, a circulation airflow in which the cool air blown out from the below knee blowout portion 6c flows into the inside air suction port 12b of the inside/outside air switching box 12 may easily form, and the heat load of the cabin air conditioning unit 10 during cooling may be reduced.

Further, in the present embodiment, when performing the seat air conditioning operation during heating, the inside/outside air switching door 12c is controlled to be in the inside/outside air mode. Due to this, a circulation airflow in which the warm air blown out from the below knee blowout portion 6c flows into the inside air suction port 12b of the inside/outside air switching box 12 may easily form, and the heat load of the cabin air conditioning unit 10 during heating may be reduced.

Here, during heating, the inside air which has a higher temperature than outside air is circulated, and the glass W may fog. In this regard, in the present embodiment, during the heating operation, the outside air flowing in the first air passage 11b of the cabin air conditioning unit 10 is blown out toward the vehicle front glass W, so the above problem may be resolved.

Incidentally, when a passenger is sitting in the seat 2, the seat blowout portion 6a and the back blowout portion 6b are partially blocked by the body of the passenger, and due to this, the ventilation resistance in the first ventilation passage 5a and the second ventilation passage 5b in the seat ventilation passage 5 is increased.

In this regard, according to the present embodiment, the ventilation resistance of the third ventilation passage 5c is configured to be greater than the ventilation resistance of the first ventilation passage 5a and the second ventilation passage 5b when a passenger is not sitting in the seat 2. Specifically, in the present embodiment, a resistive element 5d is disposed in the third ventilation passage 5c such that the ventilation resistance of the third ventilation passage 5c is greater than the ventilation resistance of the first ventilation passage 5a and the second ventilation passage 5b when a passenger is not sitting in the seat 2. Due to this, when a passenger sits in the seat 2, it is possible to suppress the flow of air from being biased toward the third ventilation passage 5c, and thereby it is possible to ensure that a sufficient amount of air is blown out from the seat blowout portion 6a and the back blowout portion 6b. As a result, the immediacy of air conditioning may be improved.

### Second Embodiment

Next, a second embodiment will be explained with reference to FIGS. 7 to 10. As shown in FIG. 7, the present embodiment differs from the first embodiment in that a below knee opening/closing door 5e is provided in the third ventilation passage 5c of the seat ventilation passage 5. Further, in the present embodiment, the resistive element 5d shown in FIG. 1 is removed.

The below knee opening/closing door 5e is an opening/closing door that opens or closes the third ventilation passage 5c or the seat ventilation passage 5. The below knee opening/closing door 5e of the present embodiment is disposed within the third ventilation passage 5c so as to not protrude outside of the seat 2 from the below knee blowout portion 6c.

The below knee opening/closing door 5e is connected to the output side of the controller 100 shown in FIG. 3, and the operation of the below knee opening/closing door 5e is controlled according to an output signal from the controller 100. Further, the controller 100 of the present embodiment is configured to measure an elapsed time from starting the operation of the seat air conditioning unit 50.

Next, regarding the control process of the below knee opening/closing door 5e by the controller 100, FIG. 8 will be explained. FIG. 8 is a flowchart showing the flow of a control process of the below knee opening/closing door 5e performed by the controller 100. The control process shown in FIG. 8 is performed by the controller 100 in a predetermined control cycle.

As shown in FIG. 8, first, the controller 100 determines whether or not the current air conditioning operation is the seat air conditioning operation (S20). This determination process is determined based on whether the seat operation switch 115d is on or off. In other words, the controller 100 determines that the seat air conditioning operation is being performed when the seat operation switch 115d is on, and determines that the seat air conditioning operation is not being performed when the seat operation switch 115d is off.

If the result of the determination process at step S20 is that the seat air conditioning operation is not being performed, in other words, the current air conditioning operation is the non-seat air conditioning operation, the controller 100 sets the position of the below knee opening/closing door 5e to a position of closing the third ventilation passage 5c of the seat ventilation passage 5.

Conversely, if the result of the determination process at step S20 is that the seat air conditioning operation is being performed, the controller determines whether or not an elapsed time from starting the operation of the seat air conditioning unit 50 has passed a particular reference time period (S24).

Here, the reference time period is set within a range needed for immediacy of air conditioning due to blowing out air from the seat blowout portion 6a and the back blowout portion 6b (for example, 1 to 5 minutes). In other words, the reference time period is set within a range such that when air is blown out from the seat blowout portion 6a and the back blowout portion 6b, a passenger is not discomforted.

The reference time is preferably a variable parameter that increases as a temperature difference between TAO and the set temperature of the vehicle cabin set by the cabin temperature setting switch 115c increases. The need for immediacy of air conditioning increases as the gap between TAO and the set temperature of the vehicle cabin set by the cabin temperature setting switch 115c increases. Alternatively, the reference time may be a predetermined fixed time period.

If the result of the determination process at step S24 is that the elapsed time from starting the operation of the seat air conditioning unit 50 has not passed the reference time period, it is considered that continuous air blow from the seat blowout portion 6a and the back blowout portion 6b is needed. For this reason, the controller 100 sets the position of the below knee opening/closing door 5e to a position of closing the third ventilation passage 5c of the seat ventilation passage 5 (S26).

Due to this, during the seat air conditioning operation, from the start of operation of the seat air conditioning unit 50 until the elapsed time exceeds the reference time period, as shown in FIG. 9, air which has been temperature adjusted by the cabin air conditioning unit 10 is blown out from the seat blowout portion 6a and the back blowout portion 6b. In other words, the initial period of the seat air conditioning operation is an air conditioning operation with high immediacy.

Conversely, if the result of the determination process at step S24 is that the elapsed time from starting the operation of the seat air conditioning unit 50 has passed the reference time period, it is considered that the necessity of continuous air blow from the seat blowout portion 6a and the back blowout portion 6b is reduced. For this reason, the controller 100 sets the position of the below knee opening/closing door 5e to a position of opening the third ventilation passage 5c of the seat ventilation passage 5 (S28).

Due to this, once the elapsed time from the start of operation of the seat air conditioning unit 50 exceeds the reference time period, as shown in FIG. 10, air which has been temperature adjusted by the cabin air conditioning unit 10 is blown out from the seat blowout portion 6a, the back blowout portion 6b, and the below knee blowout portion 6c. In other words, after a particular time period elapses after the start of the seat air conditioning operation, excess cooling or heating of a localized area of the passenger may be reduced, and so the comfort of the passenger is accounted for during air conditioning.

Other configurations are the same as the first embodiment. with the vehicular air conditioning device 1 of the present embodiment, similar to the first embodiment, the immediacy of the seat air conditioning unit 50 may be designed for, and at the same time the comfort of a passenger may be improved.

In particular, in the present embodiment, the below knee opening/closing door 5e which opens or closes the third ventilation passage 5c or the seat ventilation passage 5 is provided. Due to this, by changing the opening degree of the below knee opening/closing door 5e according to passenger needs, it is possible to adjust an air quantity ratio between air blown out from the seat blowout portion 6a and the back blowout portion 6b which form the contact side blowout portion and air blown out from the below knee blowout portion 6c. Accordingly, it is possible to change the air blowout situation between two scenarios, in accordance with a scenario where immediacy of air conditioning is desired, and a scenario where comfort of air conditioning is desired.

Here, according to the present embodiment, during the seat air conditioning operation, according to an elapsed time from starting the operation of the seat air conditioning unit 50, an explanation is provided where the below knee opening/closing door 5e is controlled, but this is not limiting. For example, during the seat air conditioning operation, the below knee opening/closing door 5e may be controlled so as to close the third ventilation passage 5c when a temperature difference between TAO and the set temperature of the cabin temperature setting switch 115c exceeds a reference value, and to close the third ventilation passage 5c when that temperature difference does not exceed the reference value.

Further, with respect to the operation panel 115, by adding an opening/closing switch for the below knee opening/closing door 5e, the controller 100 may be configured to control the below knee opening/closing door 5e in accordance with an operation of this opening/closing switch by a passenger.

### Other Embodiments

Above, a plurality of embodiments of the present disclosure are described, but the present disclosure is not limited to these embodiments, and may be modified as appropriate. For example, the following modifications are contemplated.

(1) In the above described embodiments, the target application of the vehicular air conditioning device 1 is a vehicle which obtains vehicular propulsion force from an internal combustion engine EG, but this is not limiting. The target application of the vehicular air conditioning device 1 may be, for example, an electric vehicle which obtains vehicular propulsion force from an electric motor, or a hybrid vehicle which obtains vehicular propulsion force from both an internal combustion engine EG and an electric motor.

(2) In the above described embodiments, an example is provided where the cabin air conditioning unit 10 may implement an inside/outside air two phase mode, but this is not limiting. The cabin air conditioning unit 10 may have a configuration which is not capable of implementing an inside/outside air two phase mode, e.g., a configuration where the partitioning plate 11a is not provided.

(3) In the above described embodiments, an example is provided in which when the seat operation switch 115d is off, the blowout mode is determined based on TAO, but this is not limiting. For example, when the seat operation switch 115d is off, the blowout mode may be determined based on the suction mode, the humidity in the vehicle cabin, etc. Specifically, it may be selected such that the inside air mode is during the face mode, and the inside/outside air mode is during the bi-level mode or the foot mode. Further, the outside air mode may be during when the humidity in the vehicle cabin exceeds a reference humidity.

(4) In the above described embodiments, when the seat operation switch 115d is on, the suction mode is preferably selected to be the inside air mode or the inside/outside air mode, but this is not limiting. For example, when the seat operation switch 115d is on, the suction mode may be determined based on TAO in the same manner as when the operation panel 115 is off.

(5) In the above described embodiments, an example is provided where when performing the seat air conditioning operation during cooling, cool air is blown out from the second blowout opening portion 19b and the fourth blowout opening portion 19d, but this is not limiting. For example, when performing the seat air conditioning operation during cooling, cool air may be blown out from only the fourth blowout opening portion 19d instead.

Further, in the above described embodiments, an example is provided where when performing the seat air conditioning operation during heating, warm air is blown out from the first blowout opening portion 19a, the third blowout opening portion 19c, and the fourth blowout opening portion 19d, but this is not limiting. For example, when performing the seat air conditioning operation during heating, warm air may be blown out from the first blowout opening portion 19a and the fourth blowout opening portion 19d, blown out from only the fourth blowout opening portion 19d, etc.

(6) In the above described embodiments, needlessly to say, elements configuring the embodiments are not necessarily indispensable as a matter of course, except when the elements are particularly specified as indispensable or when the elements are considered as obviously indispensable in principle.

(7) In the above described embodiments, when numerical values such as the number, figures, quantity, a range of configuration elements in the embodiments are described, the numerical values are not limited to a specific number, except when the elements are particularly specified as indispensable and the numerical values are obviously limited to the specific number in principle.

(8) In the above described embodiments, when a shape, a positional relationship, and the like of a configuration element and the like are mentioned, the shape, the positional relationship, and the like are not limited thereto excluding a particularly stated case and a case of being limited to specific shape, positional relationship, and the like based on the principle.

What is claimed is:

1. A vehicular air conditioning device for air conditioning a vehicle cabin, comprising:
a cabin air conditioning unit including
a cabin side ventilator that ventilates air toward the vehicle cabin, and
a temperature adjusting unit that adjusts a temperature of a ventilation air ventilated by the cabin side ventilator; and
a seat air conditioning unit including
a seat side ventilator that ventilates air toward a seat ventilation passage formed in a seat, and
a ventilation duct that guides at least a portion of the air which is temperature adjusted by the temperature adjusting unit toward an air intake side of the seat side ventilator, wherein
a plurality of seat side blowout portions that blow out air which flows in the seat ventilation duct are formed in the seat, and
the plurality of seat side blowout portions include
a contact side blowout portion which is formed on a surface of a portion of the seat which come into contact with a passenger when the passenger sits in the seat, and
a below knee side blowout portion which is formed on a portion of the seat that faces a below knee region of the passenger.

2. The vehicular air conditioning device of claim 1, wherein
the cabin air conditioning unit includes an inside/outside air switching box which includes
an outside air suction port which sucks in air outside of the vehicle cabin,
an inside air suction port which sucks in air inside the vehicle cabin, and
a ratio adjustment unit that adjusts a ratio between an intake amount of outside air introduced from the outside air suction port and an intake amount of inside air introduced from the inside air suction port, and
the below knee side blowout portion is formed closer toward a vehicle rear side as compared to the inside/outside air switching box, and is configured to blowout air toward a vehicle front side.

3. The vehicular air conditioning device of claim 2, further comprising:
a seat air conditioning switching unit that switches between
a seat air conditioning operation in which both the cabin side ventilator and the seat side ventilator are operated to air condition the vehicle cabin, and
a non-seat air conditioning operation in which the cabin side ventilator is operated while the seat side ventilator is stopped to air condition the vehicle cabin; and
a suction mode switching unit that controls the ratio adjustment unit to switch between
an inside air mode that introduces the air inside the vehicle cabin from the inside air suction port among the outside air suction port and the inside air suction port,
an outside air mode that introduces the air outside the vehicle cabin from the outside air suction port among the outside air suction port and the inside air suction port, and
an inside/outside air mode that introduces the air inside the vehicle cabin and the air outside of the vehicle cabin from both the outside air suction port and the inside air suction port, wherein
the cabin air conditioning unit includes an air conditioning case having formed therein a first air passage and a second air passage which independently distribute the air introduced from the inside/outside air switching box,
a seat communication portion is formed in the air conditioning case, which communicates an airflow downstream side of the second air passage to the ventilation duct,
the outside air mode is a suction mode which introduces the air outside of the vehicle cabin to both the first air passage and the second air passage,
the inside air mode is a suction mode which introduces the air inside the vehicle cabin to both the first air passage and the second air passage,
the inside/outside air mode a suction mode which introduces the air outside of the vehicle cabin to the first air passage and introduces the air inside the vehicle cabin to the second air passage, and
the suction mode switching unit controls the ratio adjustment unit so as to set the inside/outside air mode when a passenger is being warmed by the seat air conditioning operation, and controls the ratio adjustment unit so as to set the inside air mode when a passenger is being cooled by the seat air conditioning operation.

4. The vehicular air conditioning device of claim 1, wherein
the seat ventilation passage includes
a contact side ventilation passage that spans from an air discharge side of the seat side ventilator to contact side blowout portion, and
a below knee side ventilation passage that spans from the air discharge side of the seat side ventilator to the below knee blowout portion, and
the below knee side ventilation passage is configured such that, when a passenger is not sitting in the seat, a ventilation resistance of air flowing through the below knee side ventilation passage is greater than a ventilation resistance of air flowing through the contact side ventilation passage.

5. The vehicular air conditioning device of claim 1, wherein
the seat ventilation passage includes
a contact side ventilation passage that spans from an air discharge side of the seat side ventilator to contact side blowout portion, and
a below knee side ventilation passage that spans from the air discharge side of the seat side ventilator to the below knee blowout portion, and
a below knee opening/closing door that opens or closes the below knee side ventilation passage is provided in the below knee side ventilation passage.
